(19) United States
(12) Patent Application Publication
(10) Pub. No.: US 2005/0271871 A1
(43) Pub. Date: Dec. 8, 2005

(54) Solidified granular material and high proof bending stress structure member and producing process thereof

(75) Inventors: Shouji Yamazaki, Utsunomiya-shi (JP); Kazumi Yamada, Yasu-gun (JP); Naoyuki Ashida, Amagasaki-shi (JP)

Correspondence Address: ARENT FOX PLLC, 1050 CONNECTICUT AVENUE, N.W., SUITE 400, WASHINGTON, DC, 20036, US

(73) Assignees: Sekisui Plastics Co., Ltd.; Honda Motor Co., Ltd.

(21) Appl. No.: 11/138,401

(22) Filed: May 27, 2005

(30) Foreign Application Priority Data
Jun. 2, 2004 (JP) 2004-164329

(51) Int. Cl. B32B 1/00; B32B 3/00; B32B 3/26

(52) U.S. Cl. 428/304.4

(57) ABSTRACT

The high proof bending stress structure member of the present invention includes a thin wall frame structure member, a solidified granular material comprising a first granular material each of which is charged closely inside the thin wall frame structure member, such that one of the first granular material is in contact with another first granular material adjacent thereto, and a thermoplastic resin foam which fills the gap between each of the first granular material and which is welded to the surface of the first granular material whereby connecting the first granular material to each other, and the inner wall of the thin wall frame structure member with the first granular material.

### BACKGROUND OF THE INVENTION

1. Field of the Invention

The present invention relates to a solidified granular material which is used for a frame member of movable bodies such as a railroad, a vessel, an airplane, and a motorcycle, and a building structure, etc., and to a high proof bending stress structure member and producing process thereof.

Priority is claimed on Japanese Patent Application No. 2004-164329, filed Jun. 2, 2004, the content of which is incorporated herein by reference.

2. Description of Related Art

Hetherto, with respect to solidified granular material, for example, the technologies disclosed in the patent document 1 (U.S. Pat. No. 4,610,836 specification), the patent document 2 (U.S. Pat. No. 4,695,343 specification), the patent document 3 (Japanese Unexamined Patent Application, First Publication No. 2003-267266), and the patent document 4 (Japanese Unexamined Patent Application, First Publication No. 2003-276044), are proposed.

The structural material disclosed in the patent documents 1 and 2 is one which is prepared by wrapping glass bulbs being coated with an adhesive with glass fiber crossing to be solidified, and the resultant solidified material is inserted inside a frame member cross section in order to increase the rigidity of the body.

The vehicles frame structure and the solidified granular material disclosed in the document 3 is prepared by filling inside a frame member, etc., with the first granular material and the second granular material which is hollow so as to bind the first granular material through the hollow second granular material to be solidified, such that it absorbs the impact strength of a vehicle frame member efficiently.

The solidified granular material disclosed in the document 4 is one which is prepared by mixing the first granular material and the second granular material which is prepared by covering a solid or liquid which is vaporized to expand with a shell made of a thermoplastic resin, and charging the resultant mixture into the frame member, such that which absorbs the impact strength of a vehicle frame member efficiently. If the first granular material and the second granular material are heated together with the frame member, the second granular material is softened and expanded and simultaneously the surface thereof is melt, thereby binding the second granular material with the first granular material to be solidified.

In collapse of the building generated due to a collision of vehicles, or an earthquake, etc., a thin wall frame structure member bends enormously. If the thin wall frame structure member bends enormously, the cross-sectional dimension decreases to deteriorate the proof bending stress. FIG. 1A is a graph showing the correlation between the bending stroke at a thin wall frame structure member only and the proof stress, and the correlation between the bending stroke and the cross section height. In this graph, as shown in FIG. 1B, the bending stroke is defined as the difference (unit: mm) between the bottom position of the thin wall frame structure member A before the load is loaded and the bottom position thereof after the load is loaded, in the case in which a predetermined load is loaded to the center of the frame structure member of which ends are held. Moreover, the cross-sectional height was, as shown in FIG. 1C, defined as the thickness (remaining amount, unit: mm) of a bent part B generated when a predetermined load is loaded.

As can be seen from the graph of FIG. 1A, when the thin wall frame structure member only, once a large bending deformation generates, the proof bending stress deteriorates suddenly. This deterioration of the proof bending stress may cause reduction of the amount of collision energy absorption of vehicles and rapid collapse of a building.

In order to ease this sudden deterioration of the proof bending stress, it has been attempted to fill inside the structure member with a foaming resin, such as foaming polyurethane resin. However, only by filling inside the structure member with a foaming resin, it is not possible to prevent the deterioration of the proof bending stress of the structure member. FIG. 2 is a graph showing bending stroke of a thin frame structure member only (not filled), and bending strokes of thin wall frame structure members which are filled with a foaming polyurethane resin (urethane 1 and 2). As the urethane 1 and 2, two liquids mixing type urethane was employed, the foaming rate of the urethane 1 was set to be 1.3 times, whereas the foaming rate of the urethane 2 was set to be 3.0 times.

As shown in FIG. 2, in the case in which a foaming polyurethane resin is charged inside the thin wall frame structure member, it becomes difficult to bend the thin wall frame structure member compared with a thin wall frame structure member which is not filled with a foaming resin, however, after the bending generated, the proof bending stress thereof decreases suddenly. This is because the end part of filled portion is buckled and caved in.

Filling inside the thin wall frame structure member with granular material, such as a plastic bead or a glass bulb, is a very effective method for easing the deterioration of the proof bending stress of the thin wall frame structure member, compared with the method for filling the frame structure member with a foaming resin such as a foaming polyurethane.

FIG. 3 is a graph which shows correlation between the load of the thin wall frame structure member and the stroke, when the thin wall frame structure member with various types of granular materials A to D. The granular material A is a thin wall frame structure member filled with steel beads (1.0 mm of particle diameter), the granular material B is one filled with glass beads (1.0 mm of particle diameter), the granular material C is one filled with crushed glass powder (not a globular shape but crushed infinite shape powder, 1.0 mm of particle diameter), and the granular material D is one filled with polystyrene beads (1.0 mm of particle diameter), respectively. As shown in FIG. 3, it turns out that the proof bending stress of the thin wall frame structure member filled with any of granular materials A to D can be improved, compared with the thin wall frame structure member not filled with granular material.

However, since it is very difficult to fill inside a thin wall frame structure member with granular material in a manufacturing line of automobiles and a construction field, it is necessary to fill the important point with granular material exactly at the step of manufacturing parts of the thin wall frame structure member, and to convey the thin wall frame structure member to the final assembling spot.

For that purpose, it is also necessary to solidify the granular material in order to prevent leakage of the filled granular material and changing of the filled structure of the granular material due to the vibration under conveyance.

However, if unsuitable solidifying method is performed, the weight will increase to deteriorate the efficiency, and further, even if the granular material which can ease the deterioration of the proof bending stress very well is used, if unsuitable solidifying method is performed, the effect of easing will deteriorate.

That is, suitable process for solidifying granular material necessitates to maintain or improve the effect of easing deterioration of the proof bending stress of the thin wall frame structure member by non-solidified granular material, and to suppress increasing of weight.

As a result of examination, it turns out that the suitable process for solidifying granular material with which inside a thin wall frame structure member is filled necessitates to satisfy the following conditions of (1) to (4):

(1) There are few increases in weight upon being solidified.

(2) If design load acts on a solidified body, the solidified body should collapse to return to granular materials.

(3) Upon being solidified, mechanical performance such as proof bending stress of granular materials which are not yet solidified should not be changed.

(4) Upon being solidified, initial pressure is applied inside the thin wall frame structure member.

Referring to the necessary conditions of (1) to (4) for the granular material with which inside the thin wall frame structure member above is filled, the following problems exist in the conventional technology.

In the technology disclosed in the patent documents 1 and 2, a binder (an adhesive, or resin) is employed in solidifying granular material, the weight increases, and further the solidified granular material produced thereby becomes very hard, and hence it may not collapse to return to granular materials even when a designed load acts thereon. Therefore, distortion concentrates on the corner point of the solidified body by a short stroke, such that buckling and collapsing of the thin wall frame structure member occurs to deteriorate the load suddenly. And as a result, all of the necessary conditions of the solidification in the above (1) to (4) cannot be satisfied.

In the technology disclosed in the patent document 3, the first granular material is solidified by the surface welding of the second granular material, and no binders (adhesive or resin, etc.) are employed, and hence the above necessary conditions (1) to (3) for solidifying are satisfied, but the above necessary condition (4) of the initial pressure cannot be satisfied.

In the technology disclosed in the patent document 4, as shown in FIG. 4, after mixing (part (a), in FIG. 4) the first granular material C and the second non-expanded granular material D, the resultant mixture is charged into inside the thin wall frame structure member A (part (b), in FIG. 4), then these granular materials is heated under sealed condition (part (c), in FIG. 4), to expand the second granular material D and combine the first granular material C with each other by surface welding of the expanded second granular material E (part (d), in FIG. 4). In this technology, it is possible to generate an initial pressure inside the thin wall frame structure member by expanding the second granular material E, and hence the above necessary conditions (1), (2) and (4) for solidifying can be satisfied.

However, in this technology, the second granular material E will enter space between the first granular materials C, and gap between the inner wall of the thin wall frame structure member A and the first granular material C. For example, when the expanded second granular material is inferior to the first granular material in intensity and rigidity, in an early stage of the deformation in which an external force works to the thin wall frame structure member A and deformation starts, at first only the expanded second granular material E deforms, and hence sufficient effect of improving the proof bending stress by the first granular material C cannot be demonstrated (part (e), in FIG. 4). Therefore, this technology has a problem that it cannot satisfy the above necessary condition (3) for solidifying.

The present invention was made in view of the above circumstances, and it is an object of the present invention to provide a granular material, which is charged inside a thin wall frame structure member which can improve the proof bending stress of the thin wall frame structure member remarkably, with increasing scarcely the weight for solidification, and the producing process thereof.

### SUMMARY OF THE INVENTION

In order to attain the above object, the first aspect of the present invention provides a solidified granular material including a first granular material each of which is charged closely such that one of the first granular material is in contact with another first granular material adjacent thereto, and a thermoplastic resin foam which fills the gap between each of the first granular material and which is welded to the surface of the first granular material whereby connecting the first granular material to each other.

In the solidified granular material of the present invention, it is preferred that the first granular material is one or more selected from the group consisting of a resin bead, a glass bead, a metal sphere, a ceramic bead such as a calcined glass powder, and an alumina bead.

In the solidified granular material of the present invention, it is preferred that the thermoplastic resin foam is a polystyrene type resin foam.

Moreover, the second aspect of the present invention provides a high proof bending stress structure member including: a thin wall frame structure member, a first granular material each of which is charged closely inside the thin wall frame structure member, such that one of the first granular material is in contact with another first granular material adjacent thereto, and a thermoplastic resin foam which fills the gap between each of the first granular material and which is welded to the surface of the first granular material whereby connecting the first granular material to each other, and the inner wall of the thin wall frame structure member with the first granular material.

In the high proof bending stress structure member of the present invention, it is preferred that the first granular material is one or more selected from the group consisting of a resin bead, a glass bead, a metal sphere, a ceramic bead such as a calcined glass powder, and an alumina bead.

In the high proof bending stress structure member of the present invention, it is preferred that the thermoplastic resin foam is a polystyrene type resin foam.

Moreover, the third aspect of the present invention provides a process for producing a high proof bending stress structure member including: charging a first granular material inside a thin wall frame structure member, filling gap between the first granular materials with a second granular material having a diameter of not more than 20% of diameter of the first granular material, which expands upon being heated to be a thermoplastic resin foam, while inhibiting the first granular material from moving, and heating the second granular material to be expanded into a thermoplastic resin foam which fills the gap between the first granular materials and to be welded to the surface of the first granular material to form a high proof bending stress structure member.

Moreover, the fourth aspect of the present invention provides a process for producing a high proof bending stress structure member including: charging a first granular material inside a thin wall frame structure member, filling gap between the first granular materials with a second granular material having a diameter of not more than 20% of diameter of the first granular material, which expands upon being heated to be a thermoplastic resin foam, while inhibiting the first granular material from moving, heating it to form a solidified granular material, disposing the solidified granular material inside the frame structure member, and heating again the second granular material to be expanded into a thermoplastic resin foam which fills the gap between the first granular materials and to be welded to the surface of the first granular material to form a high proof bending stress structure member.

In the process of the present invention, it is preferred that the first granular material is one or more selected from the group consisting of a resin bead, a glass bead, a metal sphere, a ceramic bead such as a calcined glass powder, and an alumina bead.

In the process of the present invention, it is preferred that the first granular material is a polystyrene type resin bead, the second granular material is a foaming polystyrene type resin granule, and the charging amount of the second granular material is within a range of 2.5 to 17 weight % of the weight of the first granular material.

### BRIEF DESCRIPTION OF THE DRAWINGS

FIG. 1A is a graph showing the correlation between the load and the remaining amount, in a thin wall frame structure member which is not filled with granular material, and the correlation between the load and the stroke.

FIG. 1B is a schematic diagram showing the method for measuring bending stroke.

FIG. 1C is a schematic diagram showing the method for measuring cross-section height.

FIG. 2 is a graph showing the correlation between the load and the stroke in a thin frame structure member which is filled with a foaming polyurethane resin.

FIG. 3 is a graph which shows correlation between the load and the stroke in a thin wall frame structure member filled with various types of granular materials.

FIG. 4 is a cross section of the principal part showing a producing process for a conventional solidified granular material in order of the steps.

FIG. 5 is a cross sectional view showing one embodiment of the solidified granular material of the present invention.

FIGS. 6A and 6B show one embodiment of a high proof bending stress structure member of the present invention, FIG. 6A is a side view of the high proof bending stress structure member, and FIG. 6B is an X-X part cross section in FIG. 6A.

FIG. 7 is a cross section of the principal part showing the first embodiment of the producing process for a solidified granular material of the present invention in order of the steps.

FIG. 8 is a cross section of the principal part showing the second embodiment of the producing process for a solidified granular material of the present invention in order of the steps.

FIG. 9 is a perspective view of the thin square pole used for production of Working Example of the present invention.

FIG. 10 is a cross section of the principal part showing the producing process of Working Example 1 of the present invention in order.

FIG. 11 is a graph showing the experimental result of Working Example 1 of the present invention, which shows the correlation between the load and the displacement of the high proof bending stress structure member.

FIG. 12 is a graph showing an increasing degree of the increase in mass and the amount of absorbed energies of Working Example 1.

FIG. 13 is a graph showing the experimental result of Working Example 2 of the present invention, which shows the correlation between the load and the displacement of a high proof bending stress structure member.

FIG. 14 is a graph showing the correlation between the mixing percentage (the weight of the second granular material/the weight of the first granular material) and the energy efficiency (the amount of absorbed energies/the weight of the product) of a high proof bending stress structure member of the present invention.

FIG. 15 is a graph showing the correlation between the load and the stroke of the test pieces of one which is filled with glass beads solidified by a conventional technology and one which is filled with glass beads not solidified, as reference examples.

### DETAILED DESCRIPTION OF THE INVENTION

Hereafter, an example of the process for producing of the present invention will be explained with referring to drawings.

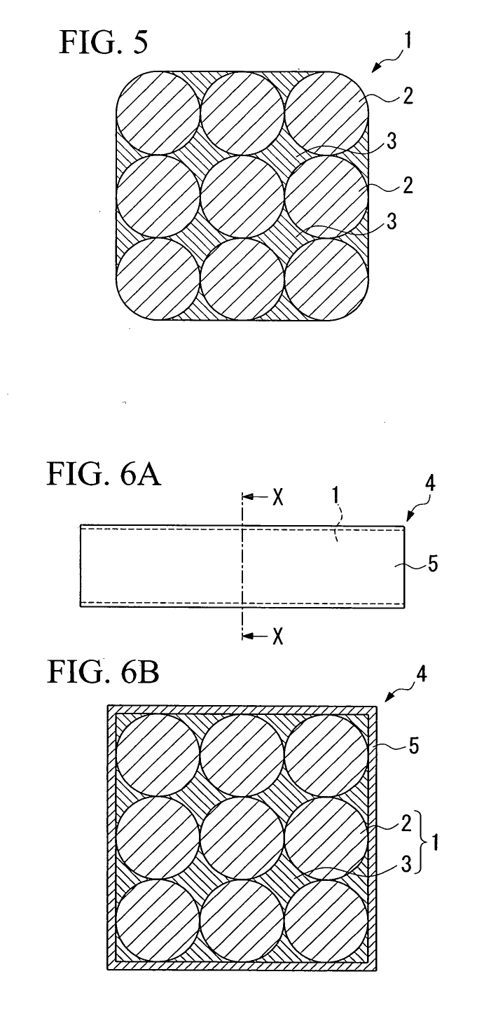

FIG. 5 is a cross section showing one embodiment of a solidified granular material of the present invention. A solidified granular material 1 of this embodiment consists of a first granular material 2 each of which is charged closely such that one of the first granular material 2 is in contact with another first granular material 2 adjacent thereto, and a thermoplastic resin foam 3 which fills the gap between each of the first granular material 2 and which is welded to the surface of the first granular material 2 whereby connecting the first granular material 2 to each other.

As the first granular material 2, for example, one or more selected from the group consisting of resin beads, glass beads, a metal sphere, ceramic beads such as calcined glass powder, and an alumina beads can be exemplified. Among these granular materials, the resin beads are light in weight and inexpensive, and hence the resin beads are particularly preferred for producing a solidified granular material used in transport machines, such as an automobile, an airplane, and a motorcycle, etc., or a high proof bending stress structure member which is constituted from a thin wall frame structure member and such a solidified granular material charged therein.

As the resin beads, various kinds of thermoplastic resin beads and thermosetting resin beads can be used. Among theses resin beads, spherical or approximately spherical beads are obtainable at relatively low cost, and hence the resin beads which are prepared by suspending one or more of radical polymerizable vinyl type monomer containing a polymerization initiator in an aqueous medium to polymerize the vinyl type monomers are preferred. As this vinyl type monomer, for example, as a vinyl type monomer of a styrene type, styrene, alpha-methyl styrene, p-methyl styrene, t-butyl styrene, chlorostyrene, alpha-methyl styrene dimer, etc., can be exemplified. As a vinyl type monomer of an acryl type, methyl acrylate, ethyl acrylate, butyl acrylate, etc., can be exemplified. As a vinyl type monomer of a methacrylic acid type, methacrylic acid, methyl methacrylate, ethyl methacrylate, propyl methacrylate, butyl methacrylate, 2-ethyl hexyl methacrylate, octyl methacrylate, isodecyl methacrylate, lauryl methacrylate, tridecyl methacrylate, stearyl methacrylate, cyclohexyl methacrylate, etc., can be exemplified. Furthermore, vinyl cyanide type monomer such as acrylonitrile, methacrylonitrile, etc., maleimide type monomer, such as maleimide, N-methyl maleimide, N-phenyl maleimide, N-cyclohexyl maleimide, etc., and conjugate diene, such as butadiene, isoprene, etc., can be exemplified. These vinyl type monomers may be used by one sort, and may be used by two or more sorts. Moreover, it is also possible to add polyfunctional monomers, such as well-known divinyl benzene and ethylene glycol methacrylate.

As a polymerization initiator used in the above suspension polymerization, for example, organic peroxides, such as a monofunctional organic peroxide, such as lauroyl peroxide, benzoyl peroxide, t-butyl peroxy 2-ethyl hexanoate, t-butyl peroxybenzoate and t-butyl peroxy pivalate, and a difuntional organic peroxide, such as 1,1-di-t-butyl peroxy 3,3,5-trimethylsiloxane, di-t-butyl-peroxy trimethyl adipate, di-t-butyl peroxy isophthalate, azo compounds, such as azobisisobutyronitrile, and azobisdimethylvaleronitrile, etc., can be exemplified. The above polymerization initiator may be added before monomers are added, after monomers are added, or together with monomers to a polymerization vessel. The polymerization initiator is preferably used by an amount of 0.03 to 5 mass % to the total amount of monomers. Moreover, in order to adjust the molecular weight of a methacrylic acid ester type polymer, n-dodecyl mercaptan, n-octyl mercaptan, n-butyl mercaptan, tert-butyl mercaptan, etc., can be used. Polymerization temperature is selected timely within 40 to 150° C.

As a suspending agent for suspending the above vinyl type monomers into an aqueous medium, for example, water soluble high molecular compounds, such as polyvinyl alcohol, and poly vinylpyrrolidone, etc., water insoluble inorganic salts, such as tricalcium phosphate, magnesium pyrophosphate, and calcium carbonate, etc., can be exemplified. Moreover, when using water insoluble inorganic salts, anion surfactants, such as sodium dodecylbenzenesulfonate, can be added to increase suspension stability further.

The amount of adding of suspension stabilizer is varied depending on the desired average particle size of the resin particles which will be obtained finally, if the amount of addition of suspension stabilizer is increased, the average particle size of the resin particles to be obtained becomes small, whereas if the amount of addition of suspension stabilizer is decreased conversely, the average particle size of the resin particles to be obtained becomes large. Moreover, since the average particle size of the resin particles to be obtained changes depending on the agitating machine and the agitating number of suspension polymerization, the amount of addition of a suspension stabilizer, addition time, an agitating machine, and the number of agitating can be determined arbitrarily, based on the desired average particle size of the resin particles to be obtained.

The resin particles obtained by the above suspension polymerization method usually have a particle size of 0.1 to approximately 10 mm, and they are not suitable as the first granular material 2, if it is considered from a view point of filling of the second granular material. Therefore, the obtained resin particles are passed through a sieve according to the purpose to select ones having a required particle size and provided to use. As an average particle size of the first granular material 2, 0.5 to 2.0 mm is preferred. If the average particle size of the first granular material is less than 0.5 mm, the granular material becomes too light in weight, it cannot possible to make the filling structure dense. Whereas, if the average particle size of the first granular material is more than 2.0 mm, the granular material becomes too large in size, the granular material will collapse. The average particle size of ranging from 0.7 to 1.5 mm is further preferred in fluidity and strength of the granular material.

As a method for obtaining the particles having a diameter of even and suitable as the first granular material 2, the resin particles obtained by the seed polymerizing method can be exemplified. That is, the vinyl type small granules obtained by suspension polymerization are passed through a sieve beforehand to be classified, and obtained vinyl type small granules having an even particle size are suspended in an aqueous medium, and a vinyl type monomer is added continuously or intermittently thereinto to be polymerized in the presence of a polymerization initiator to obtain resin particles having an even particle size.

As the above thermoplastic resin foam 3, for example, a polystyrene type resin foam, a polyethylene type resin foam, a polypropylene type resin foam, a polyethylene terephthalate type resin foam, and a polymethacrylic acid ester type resin foam, etc., can be exemplified, and the material which can be welded to the surface of the first granular material 2 is employed. The density of the thermoplastic resin form 3 is preferably in the range of 50 to 350 g/L, and more preferably in the range of 120 to 160 g/L. If the density of the thermoplastic resin foam is less than the above range, necessary proof bending stress cannot be obtained, whereas, if the density of the thermoplastic resin foam 3 is more than the above range, the proof bending stress is likely to deteriorate after bending is generated, and hence it is not preferred.

The solidified granular material 1 of this embodiment is constituted from the first granular material 2 each of which is charged closely such that one of the first granular material 2 is in contact with another first granular material 2 adjacent thereto, and the thermoplastic resin foam 3 which fills the gap between each of the first granular material 2 and which is welded to the surface of the first granular material 2 whereby connecting the first granular material 2 to each other, and hence the solidified granular material 1 can be disposed easily inside a thin wall frame structure member, etc., without changing the filling state of the first granular material 2, and as a result, the proof bending stress of the structure member can be increased by disposing the solidified granular material 1 thereinto.

FIGS. 6A and 6B are figures which show one embodiment of the high proof bending stress structure member of the present invention, FIG. 6A is a side view of the high proof bending stress structure member 4, and FIG. 6B is the X-X part cross section in FIG. 6A.

The high proof bending stress structure member 4 is constituted from a thin wall frame structure member 5, a first granular material 2 each of which is charged closely inside the thin wall frame structure member 5, such that one of the first granular material 2 is in contact with another first granular material 2 adjacent thereto, and a thermoplastic resin foam 3 which fills the gap between each of the first granular material 2 and which is welded to the surface of the first granular material 2 whereby connecting the first granular material 2 to each other, and the inner wall of the thin wall frame structure member 5 with the first granular material 2.

As the thin wall frame structure member 5, a pipe or a hollow member made of metal, such as carbon steel, stainless steel, an aluminium alloy, and a titanium alloy, a synthetic resin, such as ABS resin, polyamide resin, polycarbonate resin, and PPE resin, and a composite material such as a fiber-reinforced plastic (FRP) can be used.

As the first granular material 2 and the thermoplastic resin foam 3 with which inside the thin wall frame structure member 5 was filled, the same material as the first granular material 2 and the thermoplastic resin foam 3 which are used in the solidified granular material 1 of the present invention mentioned above can be used.

The high proof bending stress structure member 4 is constituted from a thin wall frame structure member 5, a first granular material 2 each of which is charged closely inside the thin wall frame structure member 5, such that one of the first granular material 2 is in contact with another first granular material 2 adjacent thereto, and a thermoplastic resin foam 3 which fills the gap between each of the first granular material 2 and which is welded to the surface of the first granular material 2 whereby connecting the first granular material 2 to each other, and the inner wall of the thin wall frame structure member 5 with the first granular material 2, and hence, even at an initial stage of deformation when an external force is applied to the thin wall frame structure member 5 and the deformation thereof starts, a load acts directly on the first granular material 2, as a result, the proof bending stress performance of the first granular material 2 can be exhibited sufficiently.

Moreover, the first granular material 2 is combined to each other, and the first granular material 2 is combined to the inner wall of the thin wall frame structure member 5, by the surface welding of the thermoplastic resin foam 3, and hence if a predetermined load is loaded, the surface welding of the thermoplastic resin foam 3 can be easily peeled and it will return to granular material, such that, it is hard to concentrate distortion on the filling part corner point of the thin wall frame structure member, and as a result, it is possible to maintain a high load to a long stroke.

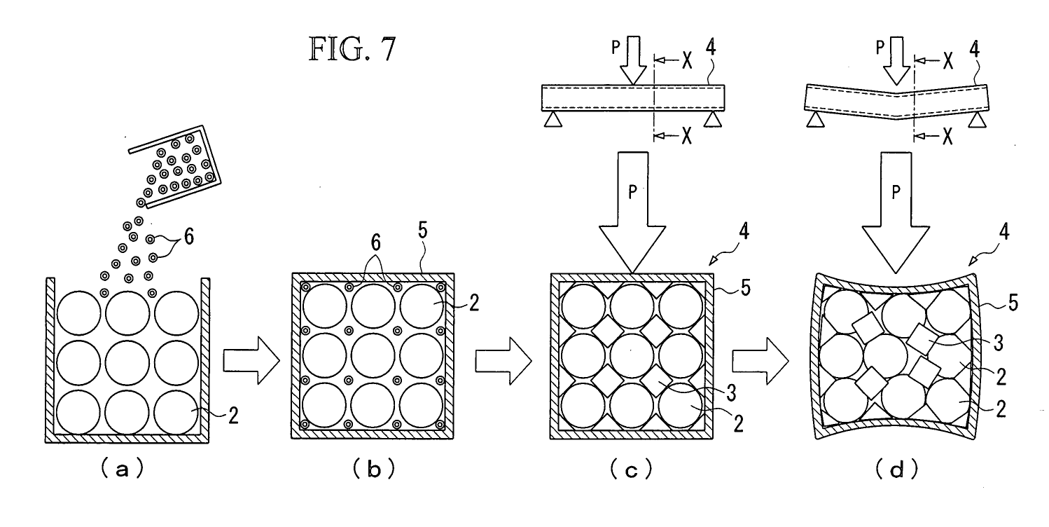

FIG. 7 is a figure showing one example of process for producing the high proof bending stress structure member of the present invention.

The process for producing a high proof bending stress structure member of this embodiment including: charging the first granular material 2 inside the thin wall frame structure member 5, filling gap between the first granular materials 2 with a second granular material 6 having a diameter of not more than 20% of diameter of the first granular material 2, which expands upon being heated to be the thermoplastic resin foam 3, while inhibiting the first granular material 2 from moving, and heating the second granular material 6 to be expanded into the thermoplastic resin foam 3 which fills the gap between the first granular materials 2 and to be welded to the surface of the first granular material 2 to form the high proof bending stress structure member 4.

As the first granular material 2, for example, one or two selected from the group consisting of resin beads, glass beads, metal sphere, ceramic beads such as a calcined glass powder, and alumina beads can be exemplified.

As the thin wall frame structure member 5, a pipe or a hollow member made of metal, such as carbon steel, stainless steel, an aluminium alloy, and a titanium alloy, a synthetic resin, such as ABS resin, polyamide resin, polycarbonate resin, and PPE resin, and a composite material such as a fiber-reinforced plastic (FRP) can be used.

As the second granular material 6, foaming resin granules which are prepared by impregnating granules made of a thermoplastic resin which can be welded to the surface of the first granular material 2, for example, a polymer such as polystyrene type resin, polyethylene type resin, polypropylene type resin, and polyethylene terephthalate type resin, with an easily volatile foaming agent, are employed.

In particular, a combination of the first granular material 2 which is a polystyrene type resin bead, and the second granular material 6 which is foaming polystyrene type resin particles is preferred. In such a combination, the amount of adding the second granular material 6 is preferably within a range of 2.5 to 17 mass % of the mass of the first granular material 2, and more preferably within a range of 6 to 8 mass %. If the amount of adding the second granular material 6 becomes out of the above range, the energy efficiency (absorbed energy/product mass) of the high proof bending stress structure member to be obtained therefrom will deteriorate.

The expandable (or foaming) polystyrene type resin particles suitable as the second granular material 6 can be obtained by suspending one or more of polymerizable vinyl type monomers containing a polymerization initiator in an aqueous medium to polymerize the vinyl monomers, and then impregnating with a foaming agent. Although it is the same as in the process for producing the first granular material 2 until it is suspended to polymerize it, the target average particle size is controlled to not more than 20% of the average particle size of the first granular material 2. The average particle size of the second granular material 6 is preferably not more than 0.4 mm, more preferably within a range of 0.01 to 0.3 mm. If it becomes more than 0.4 mm, it becomes impossible to fill the gap between the first granular material 2 with the second granular material 6. If it becomes less than 0.01 mm, the grain becomes too light in weight and it becomes difficult to charge the second granular material 6.

As the easily volatile foaming agent which is impregnated into the second granular material 6, those having an easily volatility with a boiling point which is not more than the softening point of a polymer, for example, propane, butane, pentane, cyclopentane, hexane, HCFC-141b, HCDC-142b, HCFC-124, HFC-134a, HFC-152a, etc., can be exemplified, and these foaming agents can be used alone or combined with two sorts or more. The amount of easily volatile foaming agent to be used is 1 to 20 mass %, preferably 3 to 15 mass % of the total amount of the second granular material to be obtained. Although the above foaming agent may be added anytime of before the polymerization, during the polymerization, or after the polymerization, in usual, it is preferred to be added by being compressed at a latter period of polymerization or after the polymerization, thereby impregnating into the polymer particles.

After the first granular material 2 is charged inside the thin wall frame structure member 5, if the second granular material 6 having a diameter of not more than 20% of the diameter of the first granular material 2 is projected, the second granular material 6 enters into the gap between the first granular material 2 and the first granular material 2, and the gap between the first granular material 2 and the inner wall of the thin wall frame structure member 5. To this point, it is the fact which is in general widely known in granular material engineering (the foundation of granular material engineering, collection committee editing of basic volumes of granular material engineering, Nikkan Kogyo Shimbun, p 149).

Filling of the second granular material 6 may be performed by, for example, the method (A), which includes filling inside the thin wall frame structure member 5 with the first granular material 2, and thereafter fixing the upper part of the first granular material 2 with a net having a mesh through which the first granular material cannot pass, whereas the second granular material can pass, and then putting the second granular material 6 on the net and vibrating the net, or the method (B), which includes fixing the first granular material 2 with a pair of nets one of which is disposed to upper part thereof and another is disposed to lower part thereof, and thereafter applying a differential pressure by evacuating air from the bottom to fill up the second granular material 6. In the method (A), what is important is the acceleration and the vibration time, and the condition should be suitably selected such that the second granular material can be filled up uniformly. Moreover, in the method (B), for filling up the granular material, the differential pressure and the filling time are also important, and the conditions should be suitably selected by the amount of filling of the second granular material.

The technological characteristic of this producing process is that after the second granular material 6 enters into the gap between the first granular material 2 and the first granular material 2, and the gap between the first granular material 2 and the inner wall of the thin wall frame structure member 5, the second granular material 6 is expanded by heating to fill the gap between the first granular material 2 and the first granular material 2 and to weld the thermoplastic resin foam 3 to the surface of the first granular material 2, thereby combining the first granular material 2 with each other, and the inner wall of the thin wall frame structure member 5 with the first granular material to obtain a high proof bending stress structure member 4.

In the high proof bending stress structure member 4 obtained from this producing process, the load acts directly on the first granular material 2, even at an early stage of deformation when an external force works on the thin wall frame structure member 5 and deformation starts, thereby exhibiting sufficiently the proof bending stress performance of the first granular material 2.

Moreover, according to this producing process, the inner pressure can be maintained by foaming and expanding of the second granular material 6, without filling up the first granular material 2 by compressing it, and hence filling up using a special filling apparatus and compressing are not required.

Moreover, by the surface welding of the thermoplastic resin foam 3 which is derived from the foaming of the second granular material 6, combining the first granular material 2 with each other and combining the first granular material 2 with the inner wall of the thin wall frame structure member 5 are performed, and as a result, if a designated load acts, the surface welding easily collapse to be fine foam, and hence strain is prevented from being concentrated into the endpoint of expanded part of the thin wall frame structure member 5, thereby maintaining a large load over a long stroke.

Namely, according to this producing process, the following necessary conditions (1) to (4) of the method for solidifying suitably the granular material to fill up inside the thin wall frame structure member 5, that is,
(1) there are few increases in mass upon being solidified;
(2) when a designed load acts on a solidified body, the solidified body will collapse to return to a granular material;
(3) upon being solidified, mechanical performance of the granular material before solidification, such as the proof bending stress of the granular material may not be changed; and
(4) upon being solidified, the initial pressure is applied to inside the frame structure member,
   can be satisfied simultaneously, and as a result, it is possible to obtain a high proof bending stress structure member 4 which excels in the proof bending stress performance.

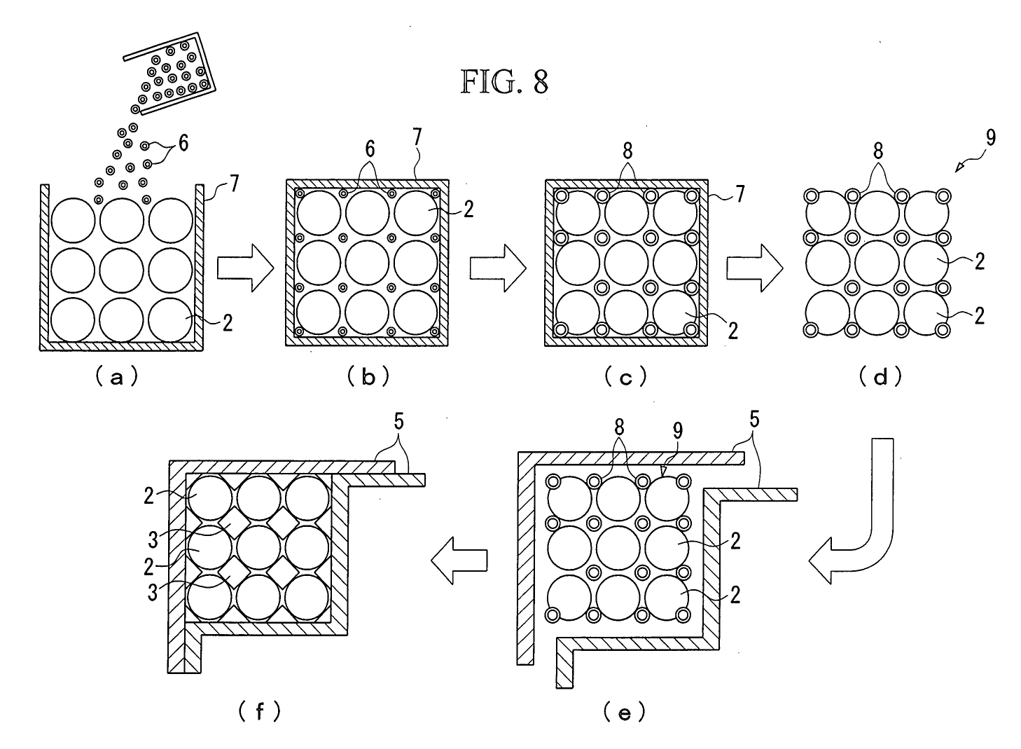

FIG. 8 is a figure showing the second example of a process for producing a high proof bending stress structure member of the present invention.

The producing process of this example including: filling inside a molding container 7 with the first granular material 2, filling the gap between the first granular materials 2 with the second granular material 6 having a diameter of not more than 20% of the diameter of the first granular material 2, which expands upon being heated to be a thermoplastic resin foam, while inhibiting the first granular material from moving, heating it to form a solidified granular material 9, disposing the solidified granular material 9 inside the frame structure member 5, and heating again the second granular material 6 to be expanded into a thermoplastic resin foam 3 which fills the gap between the first granular materials 2 and to be welded to the surface of the first granular material 2 to form a high proof bending stress structure member 4.

The above molding container 7 has an internal space (a cavity) which is the same or smaller by a little than the internal space of the thin wall frame structure member 5 in which the solidified granular material 9 is stored.

In the preliminary foaming of the second granular material 6 in the molding container 7, it is necessary to weld a preliminary foam 8 to combine the first granular materials 2 with each other, but it is not necessary to heat the preliminary foam 8 so as to fill the gap between the first granular materials 2 completely.

After the preliminary foaming is finished, the solidified granular material 9 taken out from the molding container 7 may be immediately disposed inside the thin wall frame structure member 5, or the solidified granular material 9 may be packed if necessary, and thereafter stored, conveyed to the other factory, disposed inside the thin wall frame structure member 5, and then heated to produce a high proof bending stress structure member 4.

According to the producing process of this example, almost the same effects as in the first example in the above are obtainable, and further, the solidified granular material 9 can be stored, conveyed to the other factory and disposed inside the thin wall frame structure member 5, and heated to produce a high proof bending stress structure member 4, and hence, it is possible to stock the solidified granular material 9 and produce the high proof bending stress structure member 4 in a necessary amount when it is needed, thereby making the production control easy, and as a result, it is possible to improve the convenience in production.

### WORKING EXAMPLE

Production of the First Granular Material

Into an autoclave having an internal volume of 5 litter, 2000 g of water, 7.2 g of tricalcium phosphate and 0.1 g of sodium dodecyl benzene sulfonate were charged, and thereafter, while agitating it at 140 rpm, 2000 g of styrene, 5 g of benzoyl peroxide, and 1 g of t-butyl peroxy benzoate were added, and heated to 90° C. to initiate polymerization. And it was kept as it was to polymerize at 90° C. for 6 hours, and further it was kept at 115° C. for 2 hours, and thereafter it was cooled to obtain polystyrene beads. The polystyrene beads thus obtained had diameter ranging from 0.2 to 1.5 mm, and they were sieved by 0.9 to 1.2 mm to use the part having an average diameter of 1.1 mm as the first granular material.

(Measuring Method of the Average Particle Size of the First Granular Material)

Using a low tap type shaking machine (manufactured by IIDA SEISAKUSHO Co., Ltd.), approximately 50 to 100 g of sample was classified for 10 minutes by the JIS standard sieves having aperture of 4.00 mm, aperture of 3.35 mm, aperture of 2.80 mm, aperture of 2.36 mm, aperture of 2.00 mm, aperture of 1.70 mm, aperture of 1.40 mm, aperture of 1.18 mm, aperture of 1.00 mm, aperture of 0.85 mm, aperture of 0.71 mm, aperture of 0.60 mm, aperture of 0.50 mm, aperture of 0.425 mm, aperture of 0.355 mm, aperture of 0.300 mm, aperture of 0.250 mm, aperture of 0.212 mm, and aperture of 0.180 mm, and the sample mass on the sieve net was measured, so as to regard the particle size (median diameter) which gives accumulated mass of 50% based on the accumulated mass distribution curve obtained from the result is determined as an average particle size.

(Production of the Second Granular Material)

Into an autoclave having an internal volume of 5 litter, 2000 g of water, 20 g of magnesium pyrophosphate and 1 g of sodium dodecyl benzene sulfonate were charged, and thereafter, while agitating it at 500 rpm, 1400 g of styrene, 560 g of methylmethacrylate, 40 g of α-methyl styrene and 12 g of benzoyl peroxide were added, and heated to 85° C. to initiate polymerization. And it was kept as it was to polymerize at 85° C. for 6 hours, then 240 g of isobutane was squeezed thereinto, and further it was kept at 100° C. for 1 hour, and thereafter it was cooled to obtain polystyrene beads, which were regarded as the second granular material. The second granular material thus obtained had diameter ranging from 10 μm to 200 μm, and they contained isobutane by 3.5% as a foaming agent and the average particle size was 70 μm.

(Measuring Method of the Average Particle Size of the Second Granular Material)

Measurement of the diameter of the resin beads was performed by MULTI SIZER II manufactured by Beckmann Coulter Co., Ltd. The measurement was performed with performing a calibration using an aperture of 280 μm, according to REFERENCE MANUAL FOR THE COULTER MULTISIZER (1987) of Coulter Electronics Limited issue. Specifically, 0.1 g of the resin beads were preliminarily dispersed into 10 ml of 0.1% nonionic surface active agent solution, using a touch mixer and an ultrasonic wave, and the resultant mixture was dropped by a dropping pipette into a beaker which was filled with ISOTON II (produced by Beckmann Coulter Co., Ltd.: electrolytic solution for measurement), agitating the solution lightly in the beaker which was disposed to the main body of the apparatus, and the indication of the concentration meter of the screen of the main body was adjusted over or below 10%. Next, while inputting aperture size of 280 μm, Current of 3200, Gain of 1, and Polarity of + into the main body of MULTISIZER II, measurement was performed manually. During the measurement, the inside of the beaker was lightly agitated to prevent bubbles from entering therein, and the measurement was ended when 100,000 resin beads were measured.

### Working Example 1

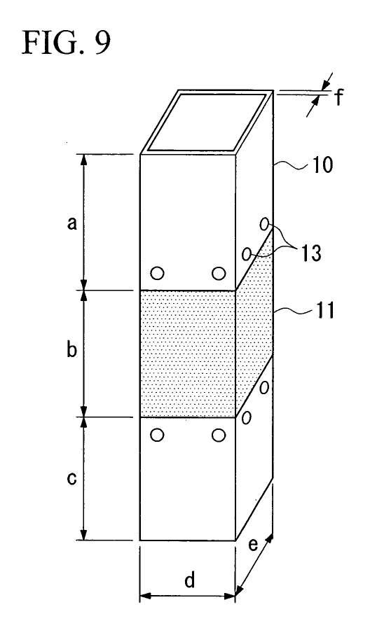

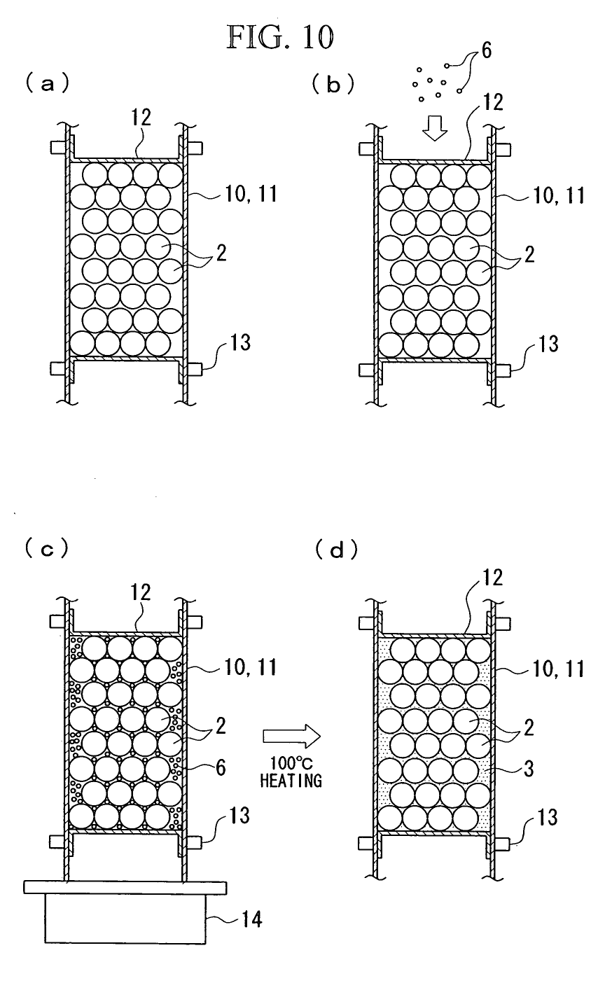

As the thin wall frame structure member, a thin wall square pole 10 made of a steel sheet having a size of each part of a to f shown in FIG. 9, in which a=100 mm, b=100 mm, c=100 mm, d=60 mm, e=60 mm, and f=1 mm was used. And to the lower side of boundary of the center part 11 (length b=100 mm), a bottom plate made of a steel sheet having a thickness of 1 mm was disposed, as shown in part (a) of FIG. 10, the bottom plate were fixed by fastening M6 bolts 13 (it will be referred to as a bolt, hereinafter) at eight portions of the lower side of the center part 11. Next, 240 g of the first granular material was charged inside the center part 11 through upper part thereof. Thereafter, a member constituted from a steel sheet frame and a net made of stainless steel (it will be referred to as SUS net, hereinafter) 12 having a thickness of 0.5 mm fixed to the steel sheet frame was placed on the upper side boundary of the center part 11, and the SUS net 12 was fixed by fastening the bolts 13 at eight portions on the upper side of the center part 11, as shown in part (a) of FIG. 10, in such a state that the first granular material 2 filled up inside the center part 11 may not displace.

Next, as shown in part (b) of FIG. 10, 30 g of the second granular material 6 was placed on the SUS net 12, and then as shown in part (c) of FIG. 10, the thin wall square pole 10 itself was fixed on a vibrating table 14, and thereafter vertical vibration was applied to the thin wall square pole 10 filled with the first granular material 2, by the displacing amount of 10 mm for 5 minutes, so as to work 1 G of the exciting force, thereby filling the gap among the first granular materials 2 evenly to the lowest portion with the second granular material 6.

Next, a top plate having a thickness of 1 mm made of steel sheet was fixed on the SUS net 12, and thereafter, the thin wall square pole 10 filled up with the first granular material 2 and the second granular material 6 was allowed to stand in an atmosphere at 100° C. for 1 hour and 30 minutes, as shown in part (d) of FIG. 10, to expand the second granular material 6, thereby filling up the gap among the first granular materials 2 and welding the second granular material 6 to the first granular material 2 to form the solidified granular material. Thereafter, the thin wall square pole 10 was taken out from the atmosphere at 100° C., and was cooled to a normal temperature to obtain a test piece (it is referred to as Working Example 1, hereinafter).

### COMPARATIVE EXAMPLE 1

The same thin wall square pole 10 as that used for producing Working Example 1 was used, and a bottom plate having a thickness of 1 mm made of steel sheet was fixed to the bottom side boundary of the center part 11 thereof. The same first granular material (240 g) as in Working Example 1 was charged inside the center part 11, a top plate having a thickness of 1 mm made of steel sheet was fixed to the upper side boundary of the center part 11, without charging the second granular material therein, and only the first granular material is charged inside the center part 11 of the thin wall square pole 10 to prepare a test piece (it is referred to as Comparative Example 1).

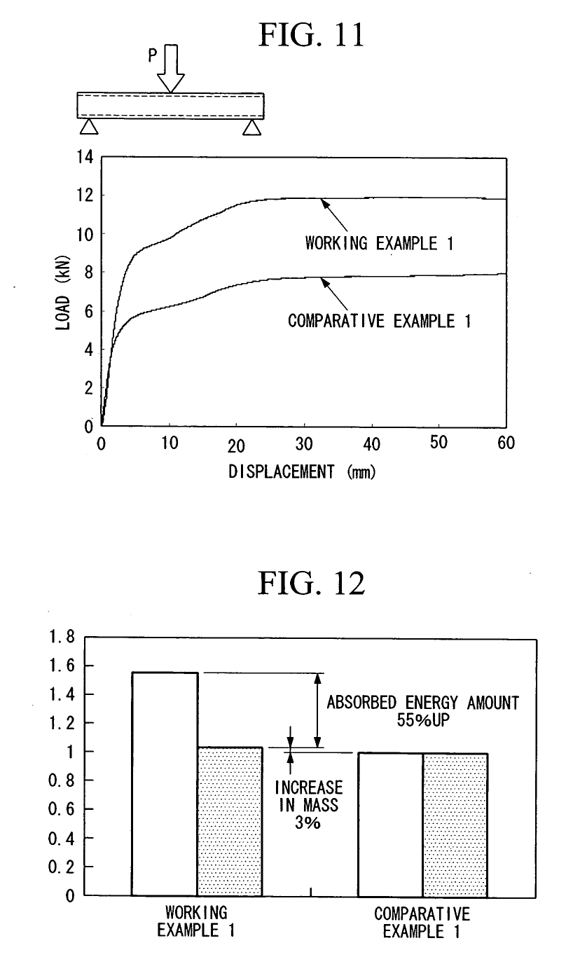

As shown in the upper part of the graph shown in FIG. 11, the both ends of a test piece were put on the support stand, load P was applied to the central portion, the amount of displacement was measured, and the correlation between the load and the displacement of each test piece of Working Example 1 and Comparative Example 1 was investigated. The result is shown in FIG. 11. Moreover, FIG. 12 is a graph comparing the amount of absorbed energies and the mass of Working Example 1 with those of Comparative Example 1, respectively.

From the result shown in FIGS. 11 and 12, it turns out that in Working Example 1 the proof bending stress performance of the first granular material before solidification is not changed in the solidification. Moreover, it turns out that in Working Example 1, despite that the increasing in mass is small (increasing in mass is 3%), the amount of absorbed energy can be increased enormously (the amount of absorbed energy was increased by 55%).

### Working Example 2

Considering the filling structure of granular material from a geometric viewpoint, if the particle diameter of the second granular material is not more than 20% of the particle diameter of the first granular material, the second granular material can enter into the gap within the filled structure of the first granular material. However, the mechanical property of a solidified granular material is influenced by the filled amount of the second granular material. When the amount of the second granular material to be charged is small, although the increase in mass is suppressed, the amount of absorbed energies does not increase, either. If the amount of the second granular material to be charged is large, the mass increases, in addition, the resultant solidified granular material becomes hard to collapse, even if a design load acts thereon, and the amount of absorbed energies will not increase.

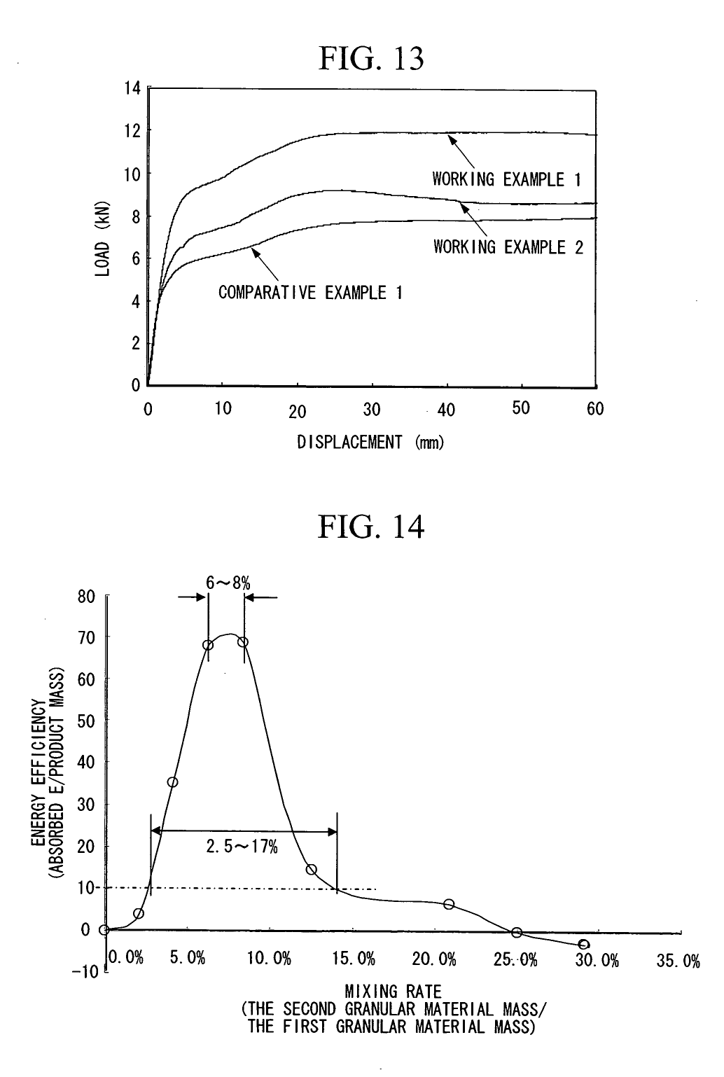

FIG. 13 is a graph showing the correlation between the load and the displacement of each of test pieces of Comparative Example 1 which was prepared using 240 g of polystyrene beads having an average particle diameter of 1.00 mm in the above as the first granular material, and expandable polystyrene beads having an average particle diameter of 70 μm in the above as the second granular material, and filling inside the thin wall square pole which is copied from a thin wall frame structure member with the first granular material only, Working Example 1 which was prepared by filling up inside the thin wall square pole with the first granular material and the second granular material and then expanding the second granular material, and Working Example 2 which was prepared similarly to Working Example 1 with the exception of changing the charging amount of the second granular material to be 10 g. From the graph shown in FIG. 13, it turns out that the mechanical property of the solidified granular material is influenced by the charged amount of the second granular material.

Next, each energy efficiency (the amount of absorbed energies/test piece mass) was investigated using the test piece prepared by changing the charged amount of the second granular material to the filled amount of the first granular material. FIG. 14 is a graph which shows the correlation between the energy efficiency and the mixing percentage (the mass of the second granular material/the mass of the first granular material). From FIG. 14, it turns out that in order to obtain a high energy efficiency, it is preferred to make the charging amount of the second granular material be within the range of 2.5 to 17% of the filling amount of the first granular material, and it is more preferred to be within the range of 6 to 8%.

### Working Example 3

When production of the solidified granular material is performed at two factories apart from each other, for example, between the place where the second granular material is charged and the place where the second granular material is expanded, the granular material is conveyed using an autotruck, etc., thereby applying external force such as vibration thereto, there may be a case where the solidified granular material of a high proof bending stress structure member does not posses proper mechanical properties.

This is because when an external force such as vibration may act on a mixture consisting of several kinds of granular materials each of which particle diameter far different from each other, particles having a large particle size will be separated from particles having a small particle size, thereby changing the filled structure.

Therefore, in the production in which each of charging of the second granular material and expanding the second granular material is performed on different place, with conveying the second granular material by autotruck etc., it is necessary to devise such that the filled position of the second granular material filled before being conveyed may not be changed.

As a result of research, as shown in FIG. 8, it is preferred to preliminarily expand the second granular material to enlarge particle diameter thereof, thereby preventing the filled position from being changed.

In this method, 1) the first granular material is charged into a container having a cross section which is smaller than that of the thin wall frame structure member, and thereafter the second granular material is charged thereinto (parts (a) and (b) in FIG. 8). 2) Next, in the container, the second granular material is preliminarily expanded to prevent the filled position from being changed and to temporally solidify the granular material (part (3) in FIG. 8). 3) The temporally solidified body is conveyed to a factory for producing a high proof bending stress structure member, where the temporally solidified body is disposed inside the thin wall frame structure member (parts (d) and (e) in FIG. 8). 4) Heating the temporally solidified body inside the thin wall frame structure member by, for example, the heat of the painting and drying line to perform a perfect expansion of the second granular material (part (f) in FIG. 8).

According to this method, four necessary conditions (1) to (4) for suitably solidifying the granular material by which the inside of the thin wall frame structure member is filled can be satisfied simultaneously, in addition, it becomes applicable to the production of an automobile in which the factory for producing parts thereof is apart far from the factory for assembling the body thereof.

### Working Example 4

The first granular material used in the present invention is preferably a granular material having excellent flowability. It is hard to form a uniform filling layer using the first granular material having poor flowability, and it is likely to form voids in the filling layer. If voids are formed in the filling layer, the second granular material gathers in the voids, as a result, it becomes impossible to perform a proper solidification, in addition, the filling structure may vary at every production, thereby causing unevenness of the performance of a high proof bending stress structure member.

Moreover, the first granular material used in the present invention is preferably a granular material having a certain degree of particle size.

If the first granular material which is flowable but is too fine, the particle size of the second granular material which can be employed therefor becomes too small, as a result, the flowability of the second granular material deteriorates due to the intermolecular force and the electrostatic force which works between particles of the second granular material. For this reason, it becomes hard for the second granular material to enter into gaps of the filling structure of the first granular material, thereby preventing the solidification from being performed sufficiently.

As a result of examining various granular materials, the first granular material used in the present invention is preferably a spherical granular material having a particle size of not less than 150 μm.

### REFERENCE EXAMPLE

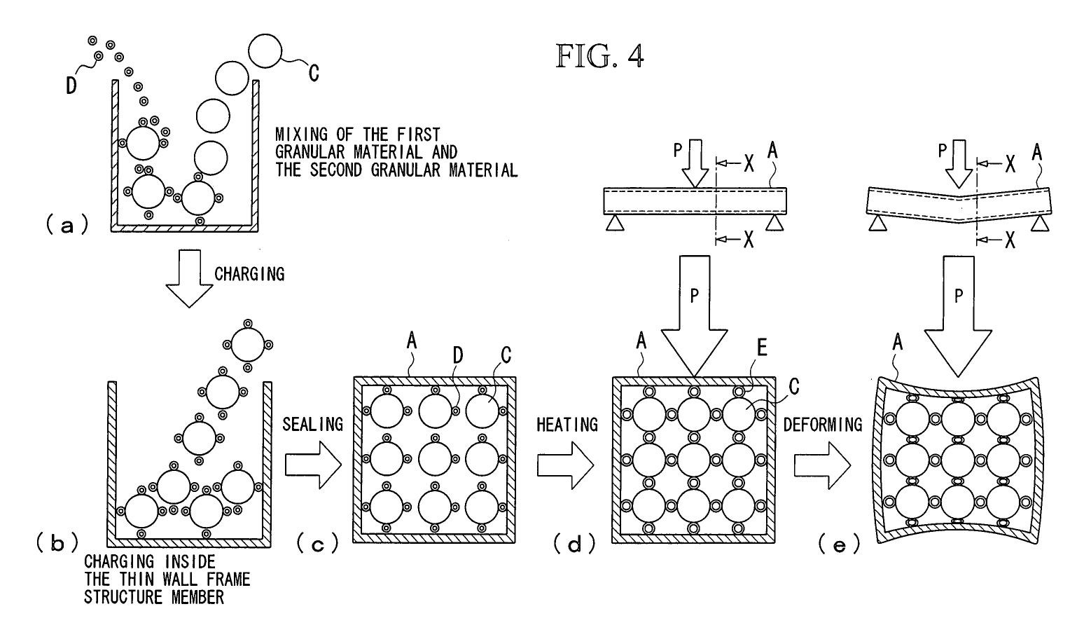

Based on the conventional technology (refer to parts (a) to (d) in FIG. 4) disclosed in the patent document 4, 568 g of the glass beads having particle size of 1 mm as the first granular material was charged inside the same thin wall square pole 10 as in Working Example 1, and then it was combined by the second granular material which was formed by covering a hydrocarbon having a low boiling point with a shell made of a thermoplastic resin to be solidified, thereby preparing a test piece (it is referred to as Reference Example 1).

For comparison, a test piece (it is referred to as Reference Example 2, hereinafter) which was constituted from only a thin wall frame structure member which was not filled up with glass beads, and a test piece (it is referred to as Reference Example 3, hereinafter) which was constituted from a thin wall frame structure member filled up with the glass beads which was not solidified were produced, respectively.

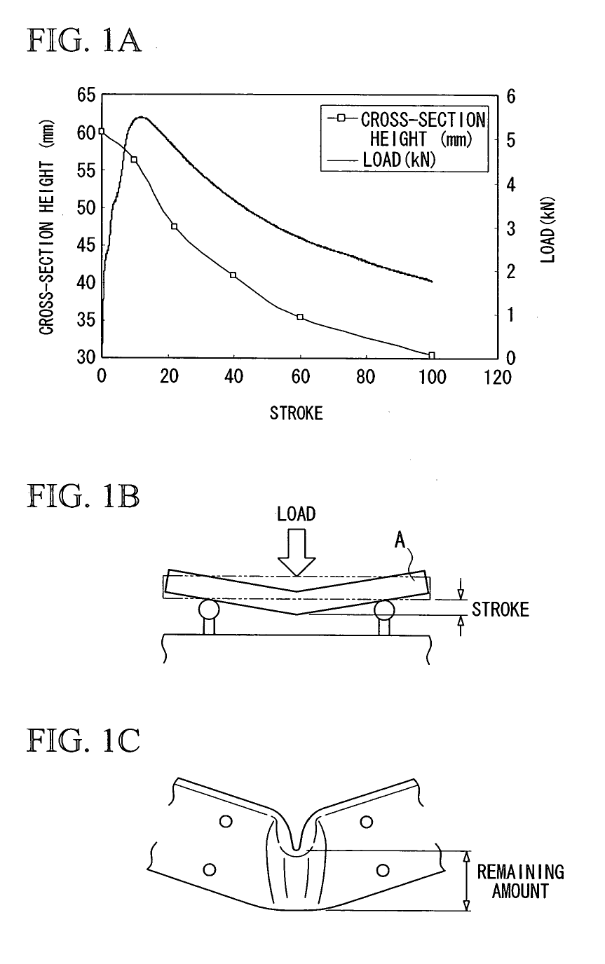

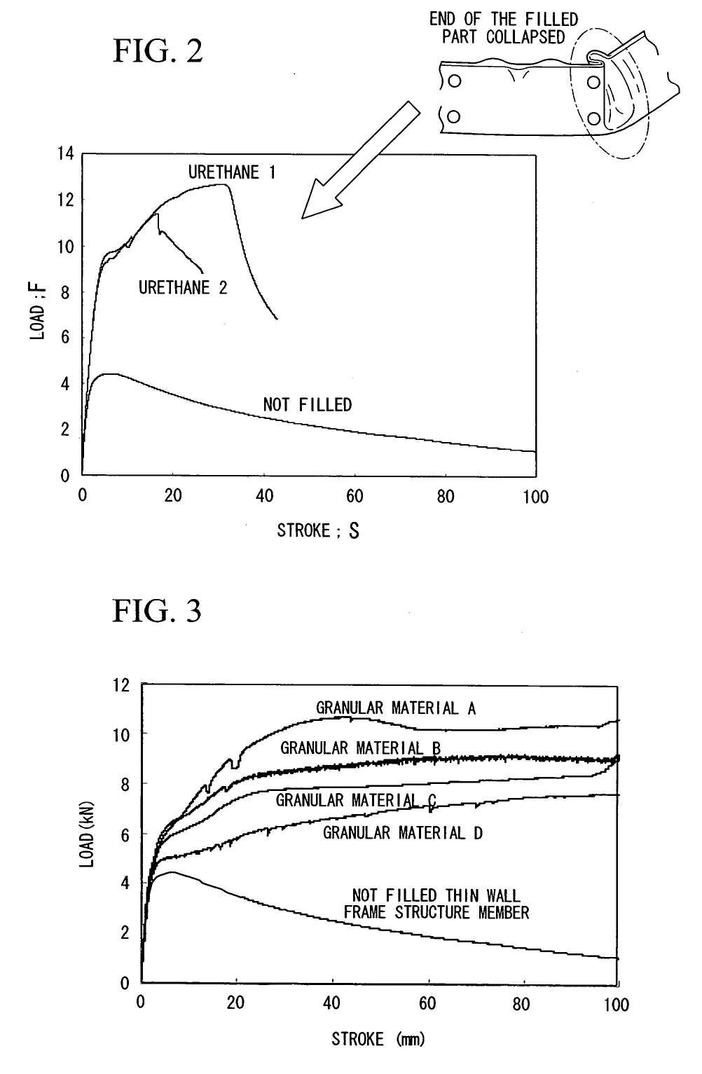

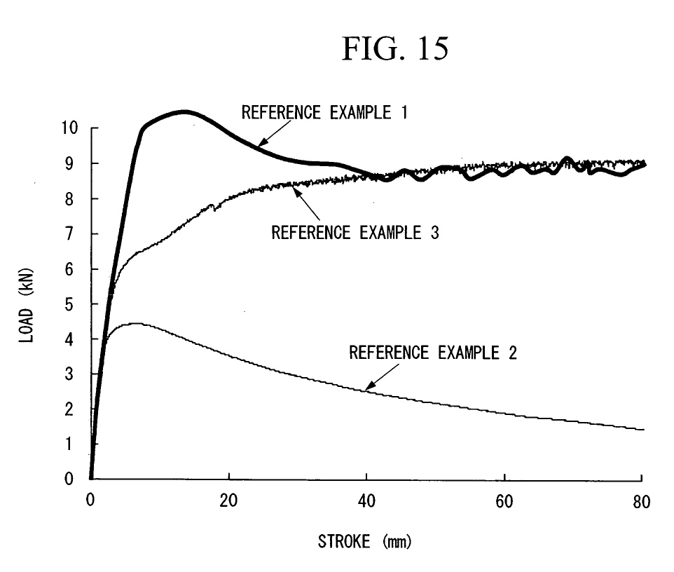

As to each test piece of the above Reference Examples 1 to 3, as shown in FIG. 1 B, the correlation between the load and the stroke was investigated. The result is shown in FIG. 15.

From the graph shown in FIG. 15, it turns out that the shape of the curve which indicates the correlation between the load and the stroke of the test piece of Reference Example 1 which is filled with the solidified glass beads according to the technology disclosed in the patent document 4 is changing, compared with the shape of the curve of the test piece of Reference Example 3 which is filled with the non-solidified glass beads. This shows that the mechanical property of the granular material filling structure was changed by the solidified granular material according to the conventional technology disclosed in the patent document 4.

The solidified granular material of the present invention is composed of the first granular material each of which is charged closely such that one of the first granular material is in contact with another first granular material adjacent thereto, and the thermoplastic resin foam which fills the gap between each of the first granular material and which is welded to the surface of the first granular material whereby connecting the first granular material to each other, and hence the solidified granular material of the present invention can be easily disposed inside the thin wall frame structure member, etc., without changing the filling condition of the first granular material, and it is possible to improve the proof bending stress of the structure member by disposing this solidified granular material.

The high proof bending stress structure member of the present invention is composed of: the thin wall frame structure member, the first granular material each of which is charged closely inside the thin wall frame structure member, such that one of the first granular material is in contact with another first granular material adjacent thereto, and the thermoplastic resin foam which fills the gap between each of the first granular material and which is welded to the surface of the first granular material whereby connecting the first granular material to each other, and the inner wall of the thin wall frame structure member with the first granular material, and hence the load acts on the first granular material directly, even at an early stage when an external force acts on the thin wall frame structure member and the deformation thereof starts, as a result, the proof bending stress performance of the first granular material can be exhibited sufficiently.

Moreover, by the surface welding of the thermoplastic resin foam 3, each of the first granular materials, and the first granular material and the inner wall of the thin wall frame structure member are combined, when a designated load acts, the thermoplastic resin foam will collapse easily to be a fine foamed body, and hence it is hard to concentrate strain on the endpoint of the filling part of the thin wall frame structure member, and it is possible to maintain a high load over a long stroke.

The process for producing a high proof bending stress structure member of the present invention is composed of: charging the first granular material inside a thin wall frame structure member, filling gap between the first granular materials with a second granular material having a diameter of not more than 20% of diameter of the first granular material, which expands upon being heated to be a thermoplastic resin foam, while inhibiting the first granular material from moving, and heating the second granular material to be expanded into a thermoplastic resin foam which fills the gap between the first granular materials and to be welded to the surface of the first granular material to form a high proof bending stress structure member. And hence, according to the high proof bending stress structure member obtainable from this producing process, the load acts on the first granular material directly, even at an early stage when an external force acts on the thin wall frame structure member and the deformation thereof starts, as a result, the proof bending stress performance of the first granular material can be exhibited sufficiently.

Moreover, according to this process, it is possible to maintain the inner pressure by the expansion of the second granular material, without charging the first granular material by compressing it, and hence, it is not necessary to fill it by a special filling apparatus or compressing.

Moreover, by the surface welding of the thermoplastic resin foam 3, each of the first granular materials, and the first granular material and the inner wall of the thin wall frame structure member are combined, when a designated load acts, the thermoplastic resin foam will collapse easily to be a fine foamed body, and hence it is hard to concentrate strain on the endpoint of the filling part of the thin wall frame structure member, and it is possible to maintain a high load over a long stroke.

Namely, according to this producing process, the following necessary conditions (1) to (4) of the method for solidifying suitably the granular material to fill up inside the thin wall frame structure member, that is, (1) there are few increases in mass upon being solidified; (2) when a designed load acts on a solidified body, the solidified body will collapse to return to a granular material; (3) upon being solidified, mechanical performance of the granular material before solidification, such as the proof bending stress of the granular material, may not be changed; and (4) upon being solidified, the initial pressure is applied to inside the frame structure member, can be satisfied simultaneously, and as a result, it is possible to obtain a high proof bending stress structure member which excels in the proof bending stress performance.

1. A solidified granular material comprising a first granular material each of which is charged closely such that one of the first granular material is in contact with another first granular material adjacent thereto, and
a thermoplastic resin foam which fills the gap between each of the first granular material and which is welded to the surface of the first granular material whereby connecting the first granular material to each other.

2. A solidified granular material as set forth in claim 1, wherein the first granular material is one or more selected from the group consisting of a resin bead, a glass bead, a metal sphere, a ceramic bead, a calcined glass powder, and an alumina bead.

3. A solidified granular material as set forth in claim 1 or 2, wherein the thermoplastic resin foam is a polystylene type resin foam.

4. A high proof bending stress structure member comprising:
a thin wall frame structure member,
a first granular material each of which is charged closely inside the thin wall frame structure member, such that one of the first granular material is in contact with another first granular material adjacent thereto, and
a thermoplastic resin foam which fills the gap between each of the first granular material and which is welded to the surface of the first granular material whereby connecting the first granular material to each other, and the inner wall of the thin wall frame structure member with the first granular material.

5. A high proof bending stress structure member as set forth in claim 4, wherein the first granular material is one or more selected from the group consisting of a resin bead, a glass bead, a metal sphere, a ceramic bead, a calcined glass powder, and an alumina bead.

6. A high proof bending stress structure member as set forth in claim 4 or 5, wherein the thermoplastic resin foam is a polystyrene type resin foam.

7. A process for producing a high proof bending stress structure member comprising:
charging a first granular material inside a thin wall frame structure member,
filling gap between the first granular materials with a second granular material having a diameter of not more than 20% of diameter of the first granular material, which expands upon being heated to be a thermoplastic resin foam, while inhibiting the first granular material from moving, and
heating the second granular material to be expanded into a thermoplastic resin foam which fills the gap between the first granular materials and to be welded to the surface of the first granular material to form a high proof bending stress structure member.

8. A process for producing a high proof bending stress structure member comprising:
filling inside a molding container with a first granular material,
filling gap between the first granular materials with a second granular material having a diameter of not more than 20% of diameter of the first granular material, which expands upon being heated to be a thermoplastic resin foam, while inhibiting the first granular material from moving,
heating it to form a solidified granular material,
disposing the solidified granular material inside the frame structure member, and
heating again the second granular material to be expanded into a thermoplastic resin foam which fills the gap between the first granular materials and to be welded to the surface of the first granular material to form a high proof bending stress structure member.

9. A process for producing a high proof bending stress structure member as set forth in claim 7 or 8, wherein the first granular material is one or more selected from the group consisting of a resin bead, a glass bead, a metal sphere, a ceramic bead, a calcined glass powder, and an alumina bead.

10. A process for producing a high proof bending stress structure member as set forth in any one of claims 7 or 8, wherein the first granular material is a polystyrene type resin bead, the second granular material is a foaming polystyrene type resin granule, and the charging amount of the second granular material is within a range of 2.5 to 17 weight % of the weight of the first granular material.
